(19) United States
(12) Patent Application Publication
(10) Pub. No.: US 2008/0208586 A1
(43) Pub. Date: Aug. 28, 2008

(54) Enabling Natural Language Understanding In An X+V Page Of A Multimodal Application

(76) Inventors: Soonthorn Ativanichayaphong, Boca Raton, FL (US); Charles W. Cross, Wellington, FL (US); Gerald M. McCobb, Delray Beach, FL (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/679,292

(22) Filed: Feb. 27, 2007

(51) Int. Cl. G10L 21/00

(52) U.S. Cl. 704/270.1

(57) ABSTRACT

Enabling natural language understanding using an X+V page of a multimodal application implemented with a statistical language model (‘SLM’) grammar of the multimodal application in an automatic speech recognition (‘ASR’) engine, with the multimodal application operating in a multimodal browser on a multimodal device supporting multiple modes of interaction including a voice mode and one or more non-voice modes, the multimodal application operatively coupled to the ASR engine through a VoiceXML interpreter, including: receiving, in the ASR engine from the multimodal application, a voice utterance; generating, by the ASR engine according to the SLM grammar, at least one recognition result for the voice utterance; determining, by an action classifier for the VoiceXML interpreter, an action identifier in dependence upon the recognition result, the action identifier specifying an action to be performed by the multimodal application; and interpreting, by the VoiceXML interpreter, the multimodal application in dependence upon the action identifier.

### BACKGROUND OF THE INVENTION

1. Field of the Invention

The field of the invention is data processing, or, more specifically, methods, apparatus, and products for enabling natural language understanding using an X+V page of a multimodal application.

2. Description of Related Art

User interaction with applications running on small devices through a keyboard or stylus has become increasingly limited and cumbersome as those devices have become increasingly smaller. In particular, small handheld devices like mobile phones and PDAs serve many functions and contain sufficient processing power to support user interaction through multimodal access, that is, by interaction in non-voice modes as well as voice mode. Devices which support multimodal access combine multiple user input modes or channels in the same interaction allowing a user to interact with the applications on the device simultaneously through multiple input modes or channels. The methods of input include speech recognition, keyboard, touch screen, stylus, mouse, handwriting, and others. Multimodal input often makes using a small device easier.

Multimodal applications are often formed by sets of markup documents served up by web servers for display on multimodal browsers. A ‘multimodal browser,’ as the term is used in this specification, generally means a web browser capable of receiving multimodal input and interacting with users with multimodal output, where modes of the multimodal input and output include at least a speech mode. Multimodal browsers typically render web pages written in XHTML+Voice (‘X+V’). X+V provides a markup language that enables users to interact with an multimodal application often running on a server through spoken dialog in addition to traditional means of input such as keyboard strokes and mouse pointer action. Visual markup tells a multimodal browser what the user interface is look like and how it is to behave when the user types, points, or clicks. Similarly, voice markup tells a multimodal browser what to do when the user speaks to it. For visual markup, the multimodal browser uses a graphics engine; for voice markup, the multimodal browser uses a speech engine. X+V adds spoken interaction to standard web content by integrating XHTML (eXtensible Hypertext Markup Language) and speech recognition vocabularies supported by VoiceXML. For visual markup, X+V includes the XHTML standard. For voice markup, X+V includes a subset of VoiceXML. For synchronizing the VoiceXML elements with corresponding visual interface elements, X+V uses events. XHTML includes voice modules that support speech synthesis, speech dialogs, command and control, and speech grammars. Voice handlers can be attached to XHTML elements and respond to specific events. Voice interaction features are integrated with XHTML and can consequently be used directly within XHTML content.

In addition to X+V, multimodal applications also may be implemented with Speech Application Tags (‘SALT’). SALT is a markup language developed by the Salt Forum. Both X+V and SALT are markup languages for creating applications that use voice input/speech recognition and voice output/speech synthesis. Both SALT applications and X+V applications use underlying speech recognition and synthesis technologies or ‘speech engines’ to do the work of recognizing and generating human speech. As markup languages, both X+V and SALT provide markup-based programming environments for using speech engines in an application's user interface. Both languages have language elements, markup tags, that specify what the speech-recognition engine should listen for and what the synthesis engine should ‘say.’ Whereas X+V combines XHTML, VoiceXML, and the XML Events standard to create multimodal applications, SALT does not provide a standard visual markup language or eventing model. Rather, it is a low-level set of tags for specifying voice interaction that can be embedded into other environments. In addition to X+V and SALT, multimodal applications may be implemented in Java with a Java speech framework, in C++, for example, and with other technologies and in other environments as well.

Current multimodal applications implemented in X+V typically model the expected voice input from a user by employing finite state grammars. Finite state grammars, however, only recognize input uttered by a user that matches one of a fixed set of phrases explicitly contained in the grammar. For example, a multimodal application employing a finite state grammar may recognize the following utterances:
“I want coffee,” or
“Please give me coffee,”
   while not recognizing the utterance “I want some coffee” because the utterance “I want some coffee” is not explicitly contained in the grammar. Because a finite state grammar with reasonable complexity can never foresee all the different sentence patterns that users employ during spontaneous speech input, a drawback to current multimodal applications implementing X+V is that these multimodal applications cannot understand or recognize natural language often employed by a user.

Another drawback with current multimodal applications that implement finite state grammars is that these multimodal applications must specify the logic for processing each individual phrase recognized by the grammar. Often, however, multiple phrases recognizable using a finite state grammar may require the same processing logic. For example, both the phrases “I want coffee” and “Please give me some coffee” require the multimodal application to perform the same task—provide the user with coffee. In such an example, the multimodal application implementing a finite state grammar must specify the same processing logic twice—the first for handling user input of “I want coffee,” and the second for handling user input of “Please give me some coffee.” Designing current multimodal applications to handle a variety of user input phrases that specify the same action, therefore, makes programming cumbersome and time consuming. As such, readers will appreciate that room for improvement exists in enabling natural language understanding using an X+V page of a multimodal application.

### SUMMARY OF THE INVENTION

Enabling natural language understanding using an X+V page of a multimodal application implemented with a statistical language model (‘SLM’) grammar of the multimodal application in an automatic speech recognition (‘ASR’) engine, with the multimodal application operating in a multimodal browser on a multimodal device supporting multiple modes of interaction including a voice mode and one or more non-voice modes, the multimodal application operatively coupled to the ASR engine through a VoiceXML interpreter, including: receiving, in the ASR engine from the multimodal application, a voice utterance; generating, by the ASR engine according to the SLM grammar, at least one recognition result for the voice utterance; determining, by an action classifier for the VoiceXML interpreter, an action identifier in dependence upon the recognition result, the action identifier specifying an action to be performed by the multimodal application; and interpreting, by the VoiceXML interpreter, the multimodal application in dependence upon the action identifier.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for enabling natural language understanding using an X+V page of a multimodal application according to embodiments of the present invention.

FIG. 2 sets forth a block diagram of automated computing machinery comprising an example of a computer useful as a voice server in enabling natural language understanding using an X+V page of a multimodal application according to embodiments of the present invention.

FIG. 3 sets forth a functional block diagram of exemplary apparatus for enabling natural language understanding using an X+V page of a multimodal application according to embodiments of the present invention.

FIG. 4 sets forth a block diagram of automated computing machinery comprising an example of a computer useful as a multimodal device in enabling natural language understanding using an X+V page of a multimodal application according to embodiments of the present invention.

FIG. 5 sets forth a flow chart illustrating an exemplary method of enabling natural language understanding using an X+V page of a multimodal application according to embodiments of the present invention.

FIG. 6 sets forth a flow chart illustrating a further exemplary method of enabling natural language understanding using an X+V page of a multimodal application according to embodiments of the present invention.

### DETAILED DESCRIPTION OF EXEMPLARY EMBODIMENTS

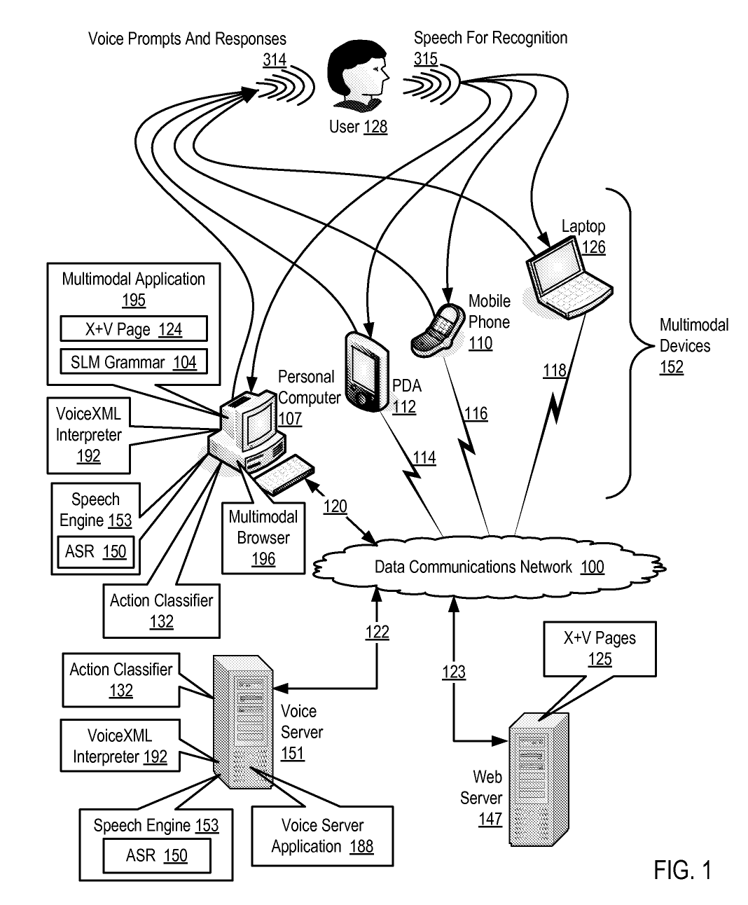

Exemplary methods, apparatus, and products for enabling natural language understanding using an X+V page of a multimodal application according to embodiments of the present invention are described with reference to the accompanying drawings, beginning with FIG. 1. FIG. 1 sets forth a network diagram illustrating an exemplary system for enabling natural language understanding using an X+V page of a multimodal application according to embodiments of the present invention. Enabling natural language understanding using an X+V page in this example is implemented with a multimodal application (195) operating in a multimodal browser (196) on a multimodal device (152). The multimodal application (195) is composed of one or more X+V pages (124). The multimodal device (152) supports multiple modes of interaction including a voice mode and one or more non-voice modes of user interaction with the multimodal application (195). The voice mode is represented here with audio output of voice prompts and responses (177) from the multimodal devices and audio input of speech for recognition (315) from a user (128). Non-voice modes are represented by input/output devices such as keyboards and display screens on the multimodal devices (152). The multimodal application is operatively coupled (195) to an automatic speed recognition (‘ASR’) engine (150) through a VoiceXML interpreter (192). The operative coupling may be implemented with an application programming interface (‘API’), a voice service module, or a VOIP connection as explained more detail below.

Enabling natural language understanding using an X+V page (124) in this example is further implemented with a statistical language model (‘SLM’) grammar (104) of the multimodal application (105) in an automatic speech recognition engine (150). The system of FIG. 1 operates generally to enable natural language understanding in an X+V page (124) of the multimodal application (195) by: receiving, in the ASR engine (150) from the multimodal application (195), a voice utterance; generating, by the ASR engine (150) according to the SLM grammar (104), at least one recognition result for the voice utterance; determining, by an action classifier (132) for the VoiceXML interpreter (192), an action identifier in dependence upon the recognition result, the action identifier specifying an action to be performed by the multimodal application (195); and interpreting, by the VoiceXML interpreter (192), the multimodal application (195) in dependence upon the action identifier.

The SLM grammar (104) in the example of FIG. 1 provides to the ASR engine (150) the words that currently may be recognized and maintains a set of training data used to assign a probability to a sequence of recognized words. An ASR engine uses the SLM grammar (104) to recognize the result of an utterance provided by a user. Consider, for example, an utterance consisting of the word sequence: “I am here.” Using the SLM grammar (104), an ASR engine may recognize the utterance as any one of the following word combinations and may assign probabilities to each combination indicated in the table below:

| WORD COMBINATION | | | PROBABILITY |
|---|---|---|---|
| Eye | am | hear | 0.12% |
| I | am | hear | 0.54% |
| Eye | am | here | 0.21% |
| I | am | here | 15.12% |

The ASR engine may estimate the probability of each word sequence by measuring the occurrence of the word order in a set of training data. Using the combination ‘I am here,’ for example, the ASR engine may compute both the number of times ‘am’ is preceded by ‘I’ and the number of times ‘here’ is preceded by ‘I am.’ Based on the probabilities assigned to each sequence of words, the ASR engine may return the recognition result as ‘I am here’ because this combination of words has the highest probability based on the set of training data specified by the SLM grammar (104). Because estimating the probability for every possible word sequence is not practically feasible, a SLM grammar may assign each word to a part of speech, such as, for example noun, verb, adjective, adverb, preposition, and so on. An ASR engine may then estimate the probability of each possible result by measuring the occurrence of the order in which the parts of speech appear in a set of test data.

SLM grammars for use in enabling natural language understanding using an X+V page of a multimodal application according to embodiments of the present invention may be expressed in any format supported by an ASR engine. An exemplary format may include the Stochastic Language Models (N-Gram) Specification promulgated by the W3C. Using the SLM grammar (104) for speech recognition advantageously allows the multimodal application (195) to recognize an unlimited number of word combinations, thus enabling natural language understanding using an X+V page of a multimodal application according to embodiments of the present invention.

In the example of FIG. 1, the X+V page (124) of the multimodal application (105) may specify the SLM grammar (104) using the VoiceXML <grammar> element as follows:
<grammar src=“gram/slmgrammar.le” type=“x-ibmlmvocabset”/>

The ‘src’ attribute specifics the URI of the definition of the exemplary SLM grammar, while the ‘type’ attribute specifies the preferred media type of the grammar. In this exemplary case, ‘x-ibmlmvocabset’ specifies the preferred media type is a grammar compiled by IBM's Embedded ViaVoice platform. Although the above example illustrates how a SLM grammar may be referenced externally, a SLM grammar's definition also may be expressed in-line in an X+V page according to any stochastic or statistical language model grammar specification as will occur to those of skill in the art such as, for example, W3C's Stochastic Language Models (N-Gram) Specification.

The system of FIG. 1 also includes an action classifier (132), a software component that specifies an action to be performed by the multimodal application (195) based on the recognition results generated by the ASR engine (150). The action classifier (132) specifies an action to be performed by the multimodal application (195) using an action identifier. Actions to be performed by the multimodal application (195) may include, for example, receiving user input, providing user output, system administration, and so on. In the example of FIG. 1, after the VoiceXML interpreter (192) receives a recognition result from an ASR engine, the VoiceXML interpreter (192) may access the action classifier (132) through an exposed API. Using the action classifier (132) to determine an action identifier in dependence upon a recognition result provided by an ASR engine advantageously simplifies processing logic in the multimodal application (195) because the task of transforming voice utterances into actions to be performed by the multimodal application (195) may be handled by processing logic external to the multimodal application (195).

A multimodal device is an automated device, that is, automated computing machinery or a computer program running on an automated device, that is capable of accepting from users more than one mode of input, keyboard, mouse, stylus, and so on, including speech input—and also displaying more than one mode of output, graphic, speech, and so on. A multimodal device is generally capable of accepting speech input from a user, digitizing the speech, and providing digitized speech to a speech engine for recognition. A multimodal device may be implemented, for example, as a voice-enabled browser on a laptop, a voice browser on a telephone handset, an online game implemented with Java on a personal computer, and with other combinations of hardware and software as may occur to those of skill in the art. Because multimodal applications may be implemented in markup languages (X+V, SALT), object-oriented languages (Java, C++), procedural languages (the C programming language), and in other kinds of computer languages as may occur to those of skill in the art, this specification uses the term ‘multimodal application’ to refer to any software application, server-oriented or client-oriented, thin client or thick client, that administers more than one mode of input and more than one mode of output, typically including visual and speech modes.

The system of FIG. 1 includes several example multimodal devices:
personal computer (107) which is coupled for data communications to data communications network (100) through wireline connection (120),
personal digital assistant (‘PDA’) (112) which is coupled for data communications to data communications network (100) through wireless connection (114),
mobile telephone (110) which is coupled for data communications to data communications network (100) through wireless connection (116), and
laptop computer (126) which is coupled for data communications to data communications network (100) through wireless connection (118).

Each of the example multimodal devices (152) in the system of FIG. 1 includes a microphone, an audio amplifier, a digital-to-analog converter, and a multimodal application capable of accepting from a user (128) speech for recognition (315), digitizing the speech, and providing the digitized speech to a speech engine for recognition. The speech may be digitized according to industry standard codecs, including but not limited to those used for Distributed Speech Recognition as such. Methods for ‘COding/DECoding’ speech are referred to as ‘codecs.’ The European Telecommunications Standards Institute (‘ETSI’) provides several codecs for encoding speech for use in DSR, including, for example, the ETSI ES 201 108 DSR Front-end Codec, the ETSI ES 202 050 Advanced DSR Front-end Codec, the ETSI ES 202 211 Extended DSR Front-end Codec, and the ETSI ES 202 212 Extended Advanced DSR Front-end Codec. In standards such as RFC3557 entitled
RTP Payload Format for European Telecommunications Standards Institute (ETSI) European Standard ES 201 108 Distributed Speech Recognition Encoding
   and the Internet Draft entitled
RTP Payload Formats for European Telecommunications Standards Institute (ETSI) European Standard ES 202 050, ES 202 211, and ES 202 212 Distributed Speech Recognition Encoding,
   the IETF provides standard RTP payload formats for various codecs. It is useful to note, therefore, that there is no limitation in the present invention regarding codecs, payload formats, or packet structures. Speech for enabling natural language understanding using an X+V page according to embodiments of the present invention may be encoded with any codec, including, for example:
AMR (Adaptive Multi-Rate Speech coder)
ARDOR (Adaptive Rate-Distortion Optimized sound codeR),
Dolby Digital (A/52, AC3),
DTS (DTS Coherent Acoustics),
MP1 (MPEG audio layer-1),
MP2 (MPEG audio layer-2) Layer 2 audio codec (MPEG-1, MPEG-2 and non-ISO MPEG-2.5),
MP3 (MPEG audio layer-3) Layer 3 audio codec (MPEG-1, MPEG-2 and non-ISO MPEG-2.5),
Perceptual Audio Coding,
FS-1015 (LPC-10),
FS-1016 (CELP),
G.726 (ADPCM),
G.728 (LD-CELP),
G.729 (CS-ACELP),
GSM,
HILN (MPEG-4 Parametric audio coding), and
others as may occur to those of skill in the art.

As mentioned, a multimodal device according to embodiments of the present invention is capable of providing speech to a speech engine for recognition. The speech engine (153) of FIG. 1 is a functional module, typically a software module, although it may include specialized hardware also, that does the work of recognizing and generating or ‘synthesizing’ human speech. The speech engine (153) implements speech recognition by use of a further module referred to in this specification as a ASR engine (150), and the speech engine carries out speech synthesis by use of a further module referred to in this specification as a text-to-speech (‘TTS’) engine (not shown). As shown in FIG. 1, a speech engine (153) may be installed locally in the multimodal device (107) itself, or a speech engine (153) may be installed remotely with respect to the multimodal device, across a data communications network (100) in a voice server (151). A multimodal device that itself contains its own speech engine is said to implement a ‘thick multimodal client’ or ‘thick client,’ because the thick multimodal client device itself contains all the functionality needed to carry out speech recognition and speech synthesis—through API calls to speech recognition and speech synthesis modules in the multimodal device itself with no need to send requests for speech recognition across a network and no need to receive synthesized speech across a network from a remote voice server. A multimodal device that does not contain its own speech engine is said to implement a ‘thin multimodal client’ or simply a ‘thin client,’ because the thin multimodal client itself contains only a relatively thin layer of multimodal application software that obtains speech recognition and speech synthesis services from a voice server located remotely across a network from the thin client. For ease of explanation, only one (107) of the multimodal devices (152) in the system of FIG. 1 is shown with a speech engine (153), but readers will recognize that any multimodal device may have a speech engine according to embodiments of the present invention.

A multimodal application (195) in this example provides speech for recognition and text for speech synthesis to a speech engine through a VoiceXML interpreter (192). A VoiceXML interpreter is a software module of computer program instructions that accepts voice dialog instructions from a multimodal application, typically in the form of a VoiceXML <form> element. The voice dialog instructions include one or more grammars, data input elements, event handlers, and so on, that advise the VoiceXML interpreter (192) how to administer voice input from a user and voice prompts and responses to be presented to a user, including vocal help prompts. The VoiceXML interpreter (192) administers such dialogs by processing the dialog instructions sequentially in accordance with a VoiceXML Form Interpretation Algorithm (‘FIA’).

As shown in FIG. 1, a VoiceXML interpreter (192) may be installed locally in the multimodal device (107) itself, or a VoiceXML interpreter (192) may be installed remotely with respect to the multimodal device, across a data communications network (100) in a voice server (151). In a thick client architecture, a multimodal device (152) includes both its own speech engine (153) and its own VoiceXML interpreter (192). The VoiceXML interpreter (192) exposes an API to the multimodal application (195) for use in providing speech recognition and speech synthesis for the multimodal application. The multimodal application (195) provides dialog instructions, VoiceXML <form> elements, grammars, input elements, event handlers, and so on, through the API to the VoiceXML interpreter, and the VoiceXML interpreter administers the speech engine on behalf of the multimodal application. In the thick client architecture, VoiceXML dialogs are interpreted by a VoiceXML interpreter on the multimodal device. In the thin client architecture, VoiceXML dialogs are interpreted by a VoiceXML interpreter on a voice server (151) located remotely across a data communications network (100) from the multimodal device running the multimodal application (195).

The VoiceXML interpreter (192) provides grammars, speech for recognition, and text prompts for speech synthesis to the speech engine (153), and the VoiceXML interpreter (192) returns to the multimodal application speech engine (153) output in the form of recognized speech, semantic interpretation results, and digitized speech for voice prompts. In a thin client architecture, the VoiceXML interpreter (192) is located remotely from the multimodal client device in a voice server (151), the API for the VoiceXML interpreter is still implemented in the multimodal device (152), with the API modified to communicate voice dialog instructions, speech for recognition, and text and voice prompts to and from the VoiceXML interpreter on the voice server (151). For ease of explanation, only one (107) of the multimodal devices (152) in the system of FIG. 1 is shown with a VoiceXML interpreter (192), but readers will recognize that any multimodal device may have a VoiceXML interpreter according to embodiments of the present invention. Each of the example multimodal devices (152) in the system of FIG. 1 may be configured to enable dynamic VoiceXML in an X+V page by installing and running on the multimodal device a multimodal application that enables dynamic VoiceXML in an X+V page according to embodiments of the present invention.

The use of these four example multimodal devices (152) is for explanation only, not for limitation of the invention. Any automated computing machinery capable of accepting speech from a user, providing the speech digitized to an ASR engine through a VoiceXML interpreter, and receiving and playing speech prompts and responses from the VoiceXML interpreter may be improved to function as a multimodal device for enabling natural language understanding using an X+V page according to embodiments of the present invention.

The system of FIG. 1 also includes a voice server (151), which is connected to data communications network (100) through wireline connection (122). The voice server (151) is a computer that runs a speech engine (153) that provides voice recognition services for multimodal devices by accepting requests for speech recognition and returning text representing recognized speech. Voice server (151) also provides speech synthesis, text to speech (‘TTS’) conversion, for voice prompts and voice responses (314) to user input in multimodal applications such as, for example, X+V applications, SALT applications, or Java voice applications.

The system of FIG. 1 includes a data communications network (100) that connects the multimodal devices (152) and the voice server (151) for data communications. A data communications network for enabling natural language understanding using an X+V page according to embodiments of the present invention is a data communications data communications network composed of a plurality of computers that function as data communications routers connected for data communications with packet switching protocols. Such a data communications network may be implemented with optical connections, wireline connections, or with wireless connections. Such a data communications network may include intranets, internets, local area data communications networks (‘LANs’), and wide area data communications networks (‘WANs’). Such a data communications network may implement, for example:
a link layer with the Ethernet™ Protocol or the Wireless Ethernet™ Protocol,
a data communications network layer with the Internet Protocol (‘IP’),
a transport layer with the Transmission Control Protocol (‘TCP’) or the User Datagram Protocol (‘UDP’),
an application layer with the HyperText Transfer Protocol (‘HTTP’), the Session Initiation Protocol (‘SIP’), the Real Time Protocol (‘RTP’), the Distributed Multimodal Synchronization Protocol (‘DMSP’), the Wireless Access Protocol (‘WAP’), the Handheld Device Transfer Protocol (‘HDTP’), the ITU protocol known as H.323, and
other protocols as will occur to those of skill in the art.

The system of FIG. 1 also includes a web server (147) connected for data communications through wireline connection (123) to network (100) and therefore to the multimodal devices (152). The web server (147) may be any server that provides to client devices X+V markup documents (125) that compose multimodal applications. The web server (147) typically provides such markup documents via a data communications protocol, HTTP, HDTP, WAP, or the like. That is, although the term ‘web’ is used to described the web server generally in this specification, there is no limitation of data communications between multimodal devices and the web server to HTTP alone. A multimodal application in a multimodal device then, upon receiving from the web sever (147) an X+V markup document as part of a multimodal application, may execute speech elements by use of a VoiceXML interpreter (192) and speech engine (153) in the multimodal device itself or by use of a VoiceXML interpreter (192) and speech engine (153) located remotely from the multimodal device in a voice server (151).

The arrangement of the multimodal devices (152), the web server (147), the voice server (151), and the data communications network (100) making up the exemplary system illustrated in FIG. 1 are for explanation, not for limitation. Data processing systems useful for enabling natural language understanding using an X+V page according to various embodiments of the present invention may include additional servers, routers, other devices, and peer-to-peer architectures, not shown in FIG. 1, as will occur to those of skill in the art. Data communications networks in such data processing systems may support many data communications protocols in addition to those noted above. Various embodiments of the present invention may be implemented on a variety of hardware platforms in addition to those illustrated in FIG. 1.

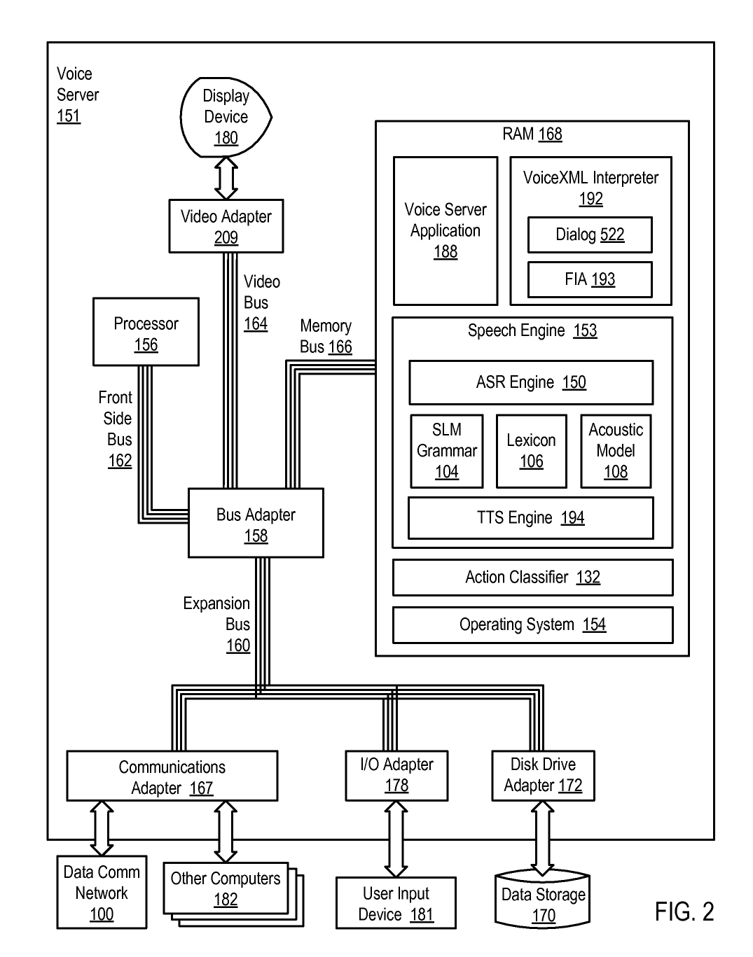

Enabling natural language understanding using an X+V page according to embodiments of the present invention in a thin client architecture may be implemented with one or more voice servers, computers, that is, automated computing machinery, that provide speech recognition and speech synthesis. For further explanation, therefore, FIG. 2 sets forth a block diagram of automated computing machinery comprising an example of a computer useful as a voice server (151) in enabling natural language understanding using an X+V page according to embodiments of the present invention. The voice server (151) of FIG. 2 includes at least one computer processor (156) or ‘CPU’ as well as random access memory (168) (‘RAM’) which is connected through a high speed memory bus (166) and bus adapter (158) to processor (156) and to other components of the voice server.

The voice server (151) of FIG. 2 operates generally to enable natural language understanding using an X+V page of a multimodal application by receiving, in the ASR engine (150) from the multimodal application, a voice utterance; generating, by the ASR engine (150) according to the SLM grammar (104), at least one recognition result for the voice utterance; determining, by an action classifier (132) for the VoiceXML interpreter (192), an action identifier in dependence upon the recognition result, the action identifier specifying an action to be performed by the multimodal application (195); and interpreting, by the VoiceXML interpreter (192), the multimodal application (195) in dependence upon the action identifier.

Stored in RAM (168) is a voice server application (188), a module of computer program instructions capable of operating a voice server in a system that is configured to enable dynamic VoiceXML in an X+V page according to embodiments of the present invention. Voice server application (188) provides voice recognition services for multimodal devices by accepting requests for speech recognition and returning speech recognition results, including text representing recognized speech, text for use as variable values in dialogs, and text as string representations of scripts for semantic interpretation. Voice server application (188) also includes computer program instructions that provide text-to-speech (‘TTS’) conversion for voice prompts and voice responses to user input in multimodal applications such as, for example, X+V applications, SALT applications, or Java Speech applications. Voice server application (188) may be implemented as a web server, implemented in Java, C++, or another language, that supports enabling natural language understanding using an X+V page according embodiments of the present invention.

The voice server (151) in this example includes a speech engine (153). The speech engine is a functional module, typically a software module, although it may include specialized hardware also, that does the work of recognizing and generating human speech. The speech engine (153) includes an automated speech recognition (‘ASR’) engine (150) for speech recognition and a text-to-speech (‘TTS’) engine (194) for generating speech. The speech engine (153) also includes a statistical language model grammar (104), a lexicon (106), and a language-specific acoustic model (108). The language-specific acoustic model (108) is a data structure, a table or database, for example, that associates SFVs with phonemes representing, to the extent that it is practically feasible to do so, all pronunciations of all the words in a human language. The lexicon (106) is an association of words in text form with phonemes representing pronunciations of each word; the lexicon effectively identifies words that are capable of recognition by an ASR engine. Also stored in RAM (168) is a Text To Speech (‘TTS’) Engine (194), a module of computer program instructions that accepts text as input and returns the same text in the form of digitally encoded speech, for use in providing speech as prompts for and responses to users of multimodal systems.

In the example of FIG. 2, the ASR engine (150) operates generally for enabling natural language understanding using an X+V page of a multimodal application by receiving a voice utterance from the multimodal application and generating at least one recognition result for the voice utterance according to the SLM grammar (104). The SLM grammar (104) communicates to the ASR engine (150) the words that currently may be recognized and maintains a set of training data used to assign a probability to a sequence of words. For precise understanding, distinguish the purpose of the grammar and the purpose of the lexicon. The lexicon associates with phonemes all the words that the ASR engine can recognize. The grammar communicates the words currently eligible for recognition. The set of words currently eligible for recognition and the set of words capable of recognition may or may not be the same. In addition, the SLM grammar (104) maintains a set of training data used by the ASR engine (150) to assign a probability to a sequence of words that specifies the likelihood that a particular combination of words recognized by the ASR engine is the combination intended by a user. As mentioned above, grammars for use in enabling natural language understanding using an X+V page according to embodiments of the present invention may be expressed in any format supported by any ASR engine, including, for example, the format described in the W3C's Stochastic Language Models (N-Gram) Specification, and in other grammar formats as may occur to those of skill in the art.

The voice server application (188) in this example is configured to receive, from a multimodal client located remotely across a network from the voice server, digitized speech for recognition from a user and pass the speech along to the ASR engine (150) for recognition. ASR engine (150) is a module of computer program instructions, also stored in RAM in this example. In carrying out enabling natural language understanding using an X+V page, the ASR engine (150) receives speech for recognition in the form of at least one digitized word and uses frequency components of the digitized word to derive a Speech Feature Vector (‘SFV’). An SFV may be defined, for example, by the first twelve or thirteen Fourier or frequency domain components of a sample of digitized speech. The ASR engine can use the SFV to infer phonemes for the word from the language-specific acoustic model (108). The ASR engine then uses the phonemes to find the word in the lexicon (106).

Also stored in RAM is an action classifier (132). The action classifier (132) is a software component that specifies an action to be performed by the multimodal application (195) based on the recognition results generated by the ASR engine (150). The action classifier (132) specifies an action to be performed by the multimodal application (195) using an action identifier. Actions to be performed by the multimodal application (195) may include, for example, receiving user input, providing user output, system administration, and so on. Using the action classifier (132) to determine an action identifier in dependence upon a recognition result provided by an ASR engine advantageously simplifies processing logic in the multimodal application (195) because the task of transforming voice utterances into actions to be performed by the multimodal application (195) may be handled by processing logic external to the multimodal application (195)

Also stored in RAM is a VoiceXML interpreter (192), a module of computer program instructions operating according to embodiments of the present invention that interprets VoiceXML segments of the multimodal application in dependence upon the action identifier. VoiceXML input to VoiceXML interpreter (192) may originate, for example, from VoiceXML clients running remotely on multimodal devices, from X+V clients running remotely on multimodal devices. In this example, VoiceXML interpreter (192) interprets and executes VoiceXML segments representing voice dialog instructions received from remote multimedia devices and provided to VoiceXML interpreter (192) through voice server application (188).

A multimodal application in a thin client architecture may provide voice dialog instructions, VoiceXML segments, VoiceXML <form> elements, and the like, to VoiceXML interpreter (192) through data communications across a network with multimodal application. The voice dialog instructions include one or more SLM grammars, data input elements, event handlers, and so on, that advise the VoiceXML interpreter how to administer voice input from a user and voice prompts and responses to be presented to a user, including vocal help prompts. The VoiceXML interpreter administers such dialogs by processing the dialog instructions sequentially in accordance with a VoiceXML Form Interpretation Algorithm (‘FIA’) (193). In this example, the VoiceXML interpreter contains a VoiceXML dialog (522), where the dialog has been provided to the VoiceXML interpreter by a multimodal application to be interpreted by the VoiceXML interpreter.

Also stored in RAM (168) is an operating system (154). Operating systems useful in voice servers according to embodiments of the present invention include UNIX™, Linux™, Microsoft NT™, IBM's AIX™, IBM's i5/OS™, and others as will occur to those of skill in the art. Operating system (154), voice server application (188), VoiceXML interpreter (192), ASR engine (150), and TTS Engine (194) in the example of FIG. 2 are shown in RAM (168), but many components of such software typically are stored in non-volatile memory also, for example, on a disk drive (170).

Voice server (151) of FIG. 2 includes bus adapter (158), a computer hardware component that contains drive electronics for high speed buses, the front side bus (162), the video bus (164), and the memory bus (166), as well as drive electronics for the slower expansion bus (160). Examples of bus adapters useful in voice servers according to embodiments of the present invention include the Intel Northbridge, the Intel Memory Controller Hub, the Intel Southbridge, and the Intel I/O Controller Hub. Examples of expansion buses useful in voice servers according to embodiments of the present invention include Industry Standard Architecture (‘ISA’) buses and Peripheral Component Interconnect (‘PCI’) buses.

Voice server (151) of FIG. 2 includes disk drive adapter (172) coupled through expansion bus (160) and bus adapter (158) to processor (156) and other components of the voice server (151). Disk drive adapter (172) connects non-volatile data storage to the voice server (151) in the form of disk drive (170). Disk drive adapters useful in voice servers include Integrated Drive Electronics (‘IDE’) adapters, Small Computer System Interface (‘SCSI’) adapters, and others as will occur to those of skill in the art. In addition, non-volatile computer memory may be implemented for a voice server as an optical disk drive, electrically erasable programmable read-only memory (so-called ‘EEPROM’ or ‘Flash’ memory), RAM drives, and so on, as will occur to those of skill in the art.

The example voice server of FIG. 2 includes one or more input/output (‘I/O’) adapters (178). I/O adapters in voice servers implement user-oriented input/output through, for example, software drivers and computer hardware for controlling output to display devices such as computer display screens, as well as user input from user input devices (181) such as keyboards and mice. The example voice server of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary voice server (151) of FIG. 2 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for enabling natural language understanding using an X+V page according to embodiments of the present invention include modems for wired dial-up communications, Ethernet (IEEE 802.3) adapters for wired data communications network communications, and 802.11 adapters for wireless data communications network communications.

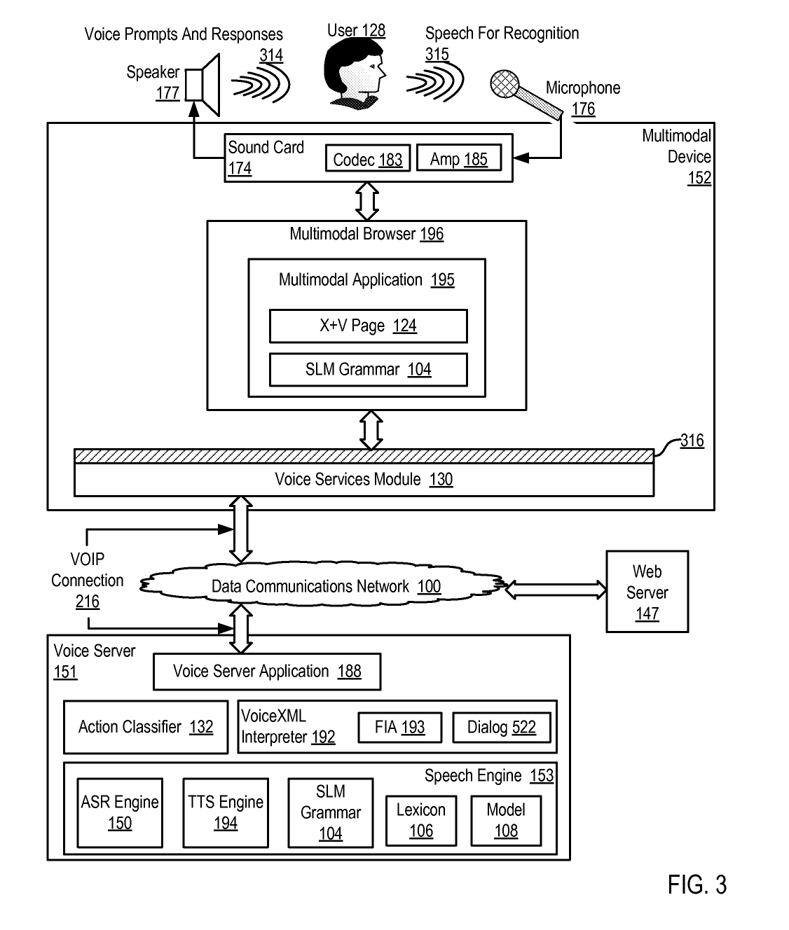

For further explanation, FIG. 3 sets forth a functional block diagram of exemplary apparatus for enabling natural language understanding using an X+V page of a multimodal application in a thin client architecture according to embodiments of the present invention. The example of FIG. 3 includes a multimodal device (152) and a voice server (151) connected for data communication by a VOIP connection (216) through a data communications network (100). A multimodal application (195) runs in a multimodal browser (196) on the multimodal device (152), and a voice server application (188) runs on the voice server (151). The multimodal application (195) may be a set or sequence of one or more X+V pages that execute in the multimodal browser (196).

The multimodal device (152) supports multiple modes of interaction including a voice mode and one or more non-voice modes. The example multimodal device (152) of FIG. 3 also supports voice with a sound card (174), which is an example of an I/O adapter specially designed for accepting analog audio signals from a microphone (176) and converting the audio analog signals to digital form for further processing by a codec (183). The example multimodal device (152) of FIG. 3 may support non-voice modes of user interaction with keyboard input, mouseclicks, a graphical user interface (‘GUI’), and so on, as will occur to those of skill in the art.

In addition to the multimodal sever application (188), the voice server (151) also has installed upon it a speech engine (153) with an ASR engine (150), a SLM grammar (104), a lexicon (106), a language-specific acoustic model (108), and a TTS engine (194), as well as a Voice XML interpreter (192) that include a form interpretation algorithm (193). VoiceXML interpreter (192) interprets and executes VoiceXML dialog instructions received from the multimodal application and provided to VoiceXML interpreter (192) through voice server application (188). VoiceXML input to VoiceXML interpreter (192) may originate from the multimodal application (195) implemented as an X+V client running remotely on the multimodal device (152).

VOIP stands for ‘Voice Over Internet Protocol,’ a generic term for routing speech over an IP-based data communications network. The speech data flows over a general-purpose packet-switched data communications network, instead of traditional dedicated, circuit-switched voice transmission lines. Protocols used to carry voice signals over the IP data communications network are commonly referred to as ‘Voice over IP’ or ‘VOIP’ protocols. VOIP traffic may be deployed on any IP data communications network, including data communications networks lacking a connection to the rest of the Internet, for instance on a private building-wide local area data communications network or ‘LAN.’

Many protocols are used to effect VOIP. The two most popular types of VOIP are effected with the IETF's Session Initiation Protocol (‘SIP’) and the ITU's protocol known as ‘H.323.’ SIP clients use TCP and UDP port 5060 to connect to SIP servers. SIP itself is used to set up and tear down calls for speech transmission. VOIP with SIP then uses RTP for transmitting the actual encoded speech. Similarly, H.323 is an umbrella recommendation from the standards branch of the International Telecommunications Union that defines protocols to provide audio-visual communication sessions on any packet data communications network.

The apparatus of FIG. 3 operates in a manner that is similar to the operation of the system of FIG. 2 described above. Multimodal application (195) is a user-level, multimodal, client-side computer program that presents a voice interface to user (128), provides audio prompts and responses (314) and accepts input speech for recognition (315). Multimodal application (195) provides a speech interface through which a user may provide oral speech for recognition through microphone (176) and have the speech digitized through an audio amplifier (185) and a coder/decoder (‘codec’) (183) of a sound card (174) and provide the digitized speech for recognition to ASR engine (150). Multimodal application (195), through the multimodal browser (196), an API (316), and a voice services module (130), then packages the digitized speech in a recognition request message according to a VOIP protocol, and transmits the speech to voice server (151) through the VOIP connection (216) on the network (100).

Voice server application (188) provides voice recognition services for multimodal devices by accepting dialog instructions, VoiceXML segments, and returning speech recognition results, including text representing recognized speech, text for use as variable values in dialogs, and output from execution of semantic interpretation scripts—as well as voice prompts. Voice server application (188) includes computer program instructions that provide text-to-speech (‘TTS’) conversion for voice prompts and voice responses to user input in multimodal applications providing responses to HTTP requests from multimodal browsers running on multimodal devices.

The voice server application (188) receives speech for recognition from a user and passes the speech through API calls to VoiceXML interpreter (192) which in turn uses an ASR engine (150) for speech recognition. The ASR engine receives digitized speech for recognition, uses frequency components of the digitized speech to derive an SFV, uses the SFV to infer phonemes for the word from the language-specific acoustic model (108), and uses the phonemes to find the speech in the lexicon (106). The ASR engine then compares speech found as words in the lexicon to words in a grammar (104) to determine whether words or phrases in speech are recognized by the ASR engine.

The multimodal application (195) is operatively coupled to the ASR engine (150) through a VoiceXML interpreter (192). In this example, the operative coupling to the ASR engine (150) through a VoiceXML interpreter (192) is implemented with a VOIP connection (216) through a voice services module (130). The voice services module is a thin layer of functionality, a module of computer program instructions, that presents an API (316) for use by an application level program in providing dialog instructions (522) and speech for recognition to a VoiceXML interpreter and receiving in response voice prompts and other responses, including action identifiers according to embodiments of the present invention. The VoiceXML interpreter, in turn, utilizes the speech engine for speech recognition and generation services and utilizes the action classifier (132) to determine action identifiers in dependence upon the recognition results generated by the ASR engine.

The voice services module (130) provides data communications services through the VOIP connection and the voice server application (188) between the multimodal device (152) and the VoiceXML interpreter (192). The API (316) is the same API presented to applications by a VoiceXML interpreter when the VoiceXML interpreter is installed on the multimodal device in a thick client architecture. So from the point of view of an application calling the API (316), the application is calling the VoiceXML interpreter directly. The data communications functions of the voice services module (130) are transparent to applications that call the API (316). At the application level, calls to the API (316) may be issued from the multimodal browser (196), which provides an execution environment for the multimodal application (195) implemented with X+V.

The system of FIG. 3 operates generally to enable natural language understanding using an X+V page of a multimodal application by receiving, in the ASR engine (150) from the multimodal application (195), a voice utterance; generating, by the ASR engine (150) according to the SLM grammar (104), at least one recognition result for the voice utterance; determining, by an action classifier (132) for the VoiceXML interpreter (192), an action identifier in dependence upon the recognition result, the action identifier specifying an action to be performed by the multimodal application (195); and interpreting, by the VoiceXML interpreter (192), the multimodal application (195) in dependence upon the action identifier.

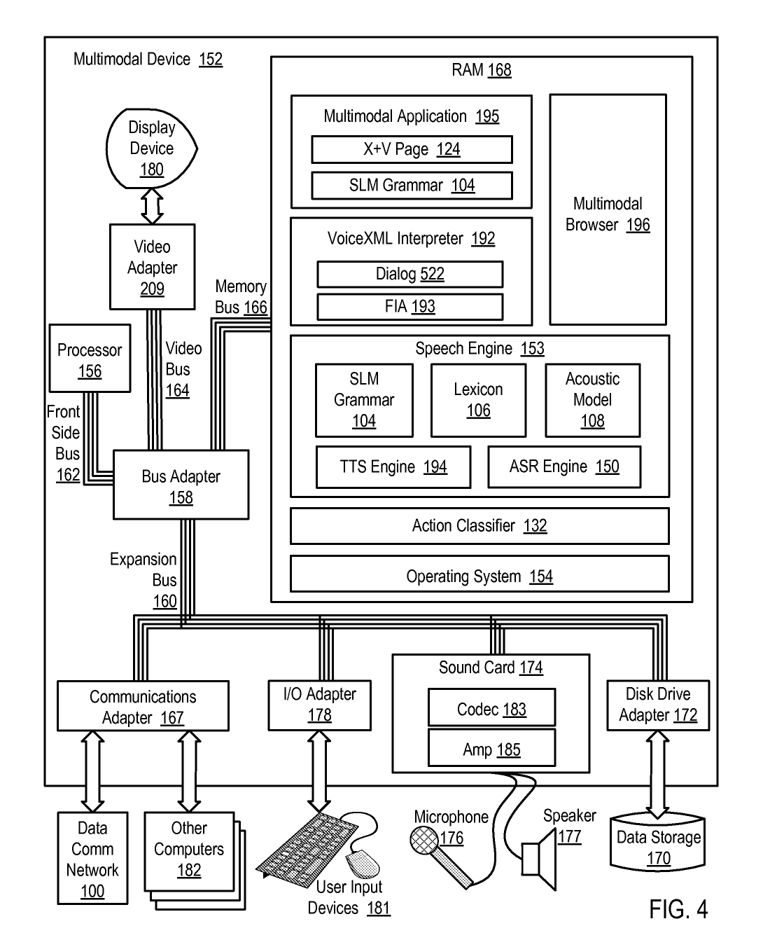

Enabling natural language understanding using an X+V page of a multimodal application according to embodiments of the present invention in thick client architectures is generally implemented with multimodal devices, that is, automated computing machinery or computers. In the system of FIG. 1, for example, all the multimodal devices (152) are implemented to some extent at least as computers. For further explanation, therefore, FIG. 4 sets forth a block diagram of automated computing machinery comprising an example of a computer useful as a multimodal device (152) in enabling natural language understanding using an X+V page of a multimodal application according to embodiments of the present invention. In a multimodal device implementing a thick client architecture as illustrated in FIG. 4, the multimodal device (152) has no connection to a remote voice server containing a VoiceXML interpreter and a speech engine. All the components needed for speech synthesis and voice recognition in enabling natural language understanding using an X+V page according to embodiments of the present invention are installed or embedded in the multimodal device itself.

The example multimodal device (152) of FIG. 4 includes several components that are structured and operate similarly as do parallel components of the voice server, having the same drawing reference numbers, as described above with reference to FIG. 2: at least one computer processor (156), frontside bus (162), RAM (168), high speed memory bus (166), bus adapter (158), video adapter (209), video bus (164), expansion bus (160), communications adapter (167), I/O adapter (178), disk drive adapter (172), an operating system (154), a VoiceXML Interpreter (192), a speech engine (153), and so on. As in the system of FIG. 2, the speech engine in the multimodal device of FIG. 4 includes an ASR engine (150), a SLM grammar (104), a lexicon (106), a language-dependent acoustic model (108), and a TTS engine (194). The VoiceXML interpreter (192) administers dialogs (522) by processing the dialog instructions sequentially in accordance with a VoiceXML Form Interpretation Algorithm (‘FIA’) (193).

The speech engine (153) in this kind of embodiment, a thick client architecture, often is implemented as an embedded module in a small form factor device such as a handheld device, a mobile phone, PDA, and the like. An example of an embedded speech engine useful for enabling natural language understanding using an X+V page according to embodiments of the present invention is IBM's Embedded ViaVoice Enterprise. The example multimodal device of FIG. 4 also includes a sound card (174), which is an example of an I/O adapter specially designed for accepting analog audio signals from a microphone (176) and converting the audio analog signals to digital form for further processing by a codec (183). The sound card (174) is connected to processor (156) through expansion bus (160), bus adapter (158), and front side bus (162).

Also stored in RAM (168) in this example is a multimodal application (195), a module of computer program instructions capable of operating a multimodal device as an apparatus that supports enabling natural language understanding using an X+V page according to embodiments of the present invention. The multimodal application (195) implements speech recognition by accepting speech utterances for recognition from a user and sending the utterance for recognition through API calls to the ASR engine (150). The multimodal application (195) implements speech synthesis generally by sending words to be used as prompts for a user to the TTS engine (194). As an example of thick client architecture, the multimodal application (195) in this example does not send speech for recognition across a network to a voice server for recognition, and the multimodal application (195) in this example does not receive synthesized speech, TTS prompts and responses, across a network from a voice server. All grammar processing, voice recognition, and text to speech conversion in this example is performed in an embedded fashion in the multimodal device (152) itself.

More particularly, multimodal application (195) in this example is a user-level, multimodal, client-side computer program that provides a speech interface through which a user may provide oral speech for recognition through microphone (176), have the speech digitized through an audio amplifier (185) and a coder/decoder (‘codec’) (183) of a sound card (174) and provide the digitized speech for recognition to ASR engine (150). The multimodal application (195) may be implemented as a set or sequence of X+V documents executing in a multimodal browser (196) or microbrowser that passes VoiceXML grammars and digitized speech by calls through an API (316) directly to an embedded VoiceXML interpreter (192) for processing. The embedded VoiceXML interpreter (192) may in turn issue requests for speech recognition through API calls directly to the embedded ASR engine (150). The embedded VoiceXML interpreter (192) may then issue requests to the action classifier (132) to determine an action identifier in dependence upon the recognized result provided by the ASR engine (150). Multimodal application (195) also can provide speech synthesis, TTS conversion, by API calls to the embedded TTS engine (194) for voice prompts and voice responses to user input.

The multimodal application (195) is operatively coupled to the ASR engine (150) through a VoiceXML interpreter (192). In this example, the operative coupling through the VoiceXML interpreter is implemented using a VoiceXML interpreter API. The VoiceXML interpreter API is a module of computer program instructions for use by an application level program in providing dialog instructions and speech for recognition to a VoiceXML interpreter and receiving in response voice prompts and other responses. The VoiceXML interpreter API presents the same application interface as is presented by the API of the voice service module (130 on FIG. 3) in a thin client architecture. At the application level, calls to the VoiceXML interpreter API may be issued from the multimodal browser (196), which provides an execution environment for the multimodal application (195) when the multimodal application is implemented with X+V. The VoiceXML interpreter (192), in turn, utilizes the speech engine (153) for speech recognition and generation services.

The multimodal application (195) in this example, running in a multimodal browser (196) on a multimodal device (152) that contains its own VoiceXML interpreter (192) and its own speech engine (153) with no network or VOIP connection to a remote voice server containing a remote VoiceXML interpreter or a remote speech engine, is an example of a so-called ‘thick client architecture,’ so-called because all of the functionality for processing voice mode interactions between a user and the multimodal application—as well as all or most of the functionality for enabling natural language understanding using an X+V page of a multimodal application according to embodiments of the present invention—is implemented on the multimodal device itself.

The multimodal device (152) in this example is configured to enable natural language understanding using an X+V page (124) of a multimodal application (195) by receiving, in the ASR engine (150) from the multimodal application (195), a voice utterance; generating, by the ASR engine (150) according to the SLM grammar (104), at least one recognition result for the voice utterance; determining, by an action classifier (132) for the VoiceXML interpreter (192), an action identifier in dependence upon the recognition result, the action identifier specifying an action to be performed by the multimodal application (195); and interpreting, by the VoiceXML interpreter (192), the multimodal application (195) in dependence upon the action identifier.

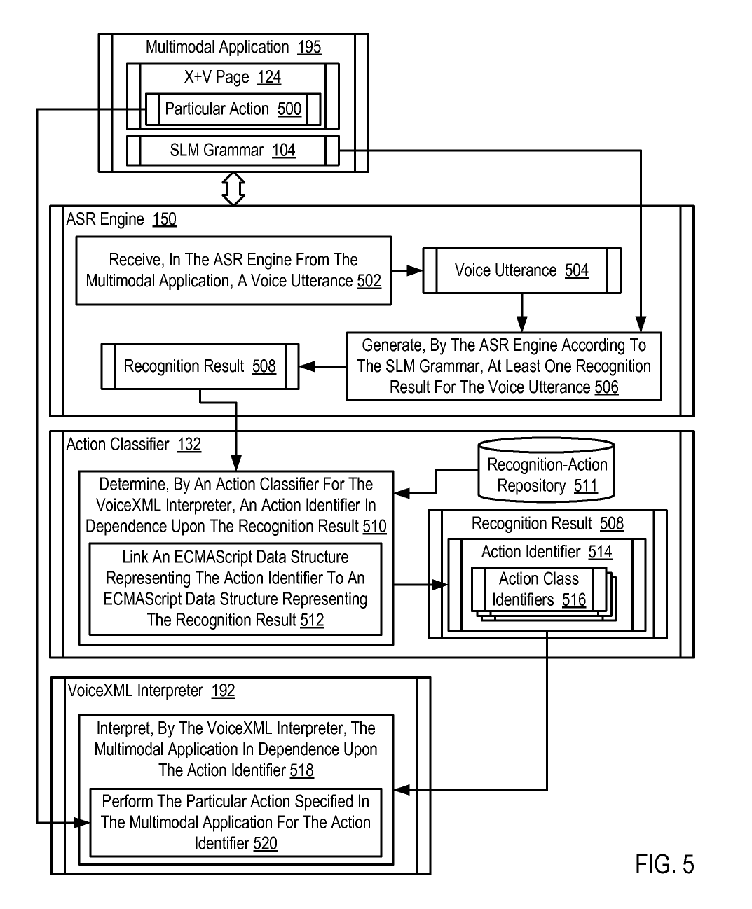

For further explanation, FIG. 5 sets forth a flow chart illustrating an exemplary method of enabling natural language understanding using an X+V page of a multimodal application according to embodiments of the present invention. Enabling natural language understanding using an X+V page in this example is implemented with a multimodal application (195), composed of at least one X+V page (124). The multimodal application (195) operates in a multimodal browser (196) on a multimodal device supporting multiple modes of interaction including a voice mode and one or more non-voice modes of user interaction with the multimodal application. The voice mode may be implemented in this example with audio output through a speaker and audio input through a microphone. Non-voice modes may be implemented by user input devices such as, for example, a keyboard and a mouse.

The multimodal application is operatively coupled to the ASR engine (150) through a VoiceXML interpreter (192). The operative coupling provides a data communications path from the multimodal application (195) to the ASR engine (150) for SLM grammars, speech for recognition, and other input. The operative coupling also provides a data communications path from the ASR engine (150) to the multimodal application (195) for recognized speech, semantic interpretation results, and other results. The operative coupling may be effected with a VoiceXML interpreter (192 on FIG. 4) when the multimodal application is implemented in a thick client architecture. When the multimodal application is implemented in a thin client architecture, the operative coupling may include a voice services module (130 on FIG. 3) and a VOIP connection (216 on FIG. 3).

The method of FIG. 5 includes receiving (502), in the ASR engine (150) from the multimodal application (195), a voice utterance (504). The voice utterance (504) of FIG. 5 represents human speech provided to the multimodal application (195) by a user of a multimodal device. As mentioned above, the multimodal application (195) may acquire the voice utterance (504) from a user through a microphone and encode the voice utterance in a suitable format for storage and transmission using any CODEC as will occur to those of skill in the art. The ASR engine (150) may receive (502) the voice utterance (504) through the operative coupling between the multimodal application (195) and the ASR engine (150) described above.

Enabling natural language understanding using an X+V page (124) of a multimodal application (195) according to the method of FIG. 5 is implemented with a statistical language model (‘SLM’) grammar (104) of the multimodal application (105) in an ASR engine (150). Through the operatively coupling between the multimodal application (195) and the ASR engine (150), the multimodal application (195) may provide the SLM grammar (104) to the ASR engine (150). The X+V page (124) of the multimodal application (105) may specify the SLM grammar (104) using the VoiceXML <grammar> element as follows:
<grammar src=“gram/slmgrammar.le” type=“x-ibmlmvocabset”/>

The ‘src’ attribute specifics the URI of the definition of the exemplary SLM grammar, while the ‘type’ attribute specifies the preferred media type of the grammar. In this exemplary case, ‘x-ibmlmvocabset’ specifies the preferred media type is a grammar compiled by IBM's Embedded ViaVoice platform. Although the above example illustrates how a SLM grammar may be referenced externally, a SLM grammar's definition also may be expressed in-line in an X+V page.

The method of FIG. 5 includes generating (506), by the ASR engine (150) according to the SLM grammar (104), at least one recognition result (508) for the voice utterance (504). The recognition result (508) of FIG. 5 represents the semantic interpretation of the voice utterance (504) provided by the user. The SLM grammar (104) of FIG. 5 provides to the ASR engine (150) the words that currently may be recognized and maintains a set of training data used to assign a probability to a sequence of recognized words.

The ASR engine (150) may generate (506) at least one recognition result (508) for the voice utterance (504) according to the method of FIG. 5 by matching words contained in the utterance with words in the SLM grammar (104), estimating a probability for each possible combination of matched words in dependence upon a set of training data contained in the SLM grammar (104), and selecting the combination of matched words having the highest probability as the recognition result. For further explanation, consider a voice utterance consisting of the phrase: “I am here.” Using the SLM grammar (104), an ASR engine may match words contained in the utterance with words in the SLM grammar (104) and estimate a probability for each possible combination of matched words in dependence upon a set of training data contained in the SLM grammar (104) to produce the following results:

| WORD COMBINATIONS | | | PROBABILITY |
|---|---|---|---|
| Eye | am | hear | 0.12% |
| I | am | hear | 0.54% |
| Eye | am | here | 0.21% |
| I | am | here | 15.12% |

The ASR engine (150) may estimate the probability of each word sequence by measuring the occurrence of the word order in a set of training data. Using the combination ‘I am here,’ for example, the ASR engine may compute both the number of times ‘am’ is preceded by ‘I’ and the number of times ‘here’ is preceded by ‘I am.’ The ASR engine (150) may then generate (506) at least one recognition result (508) for the voice utterance (504) according to the SLM grammar (104) by selecting the combination of matched words having the highest probability of being correct based on the training data for the language in the SLM grammar (104). Readers will note that generating (506) a recognition result (508) for the voice utterance (504) according to the SLM grammar (104) advantageously allows the ASR engine (150) to recognize the user's utterance without requiring the utterance to conform to a limited sets of phrases as is often required in finite state grammars.

In VoiceXML, the recognition result (508) may be represented as an ECMAScript data structure such as, for example, the ‘application.lastresult$’ array. ECMAScript data structures represent objects in the Document Object Model (‘DOM’) at the scripting level in the X+V page. The DOM is created by a multimodal browser when the X+V page of the multimodal application is loaded. The ‘application.lastresult$’ array holds information about the last recognition generated by the ASR engine (150) for the multimodal application (195). The ‘application.lastresult$’ is an array of elements where each element, application.lastresult$[i], represents a possible result through the following shadow variables:
application.lastresult$[i].confidence, which specifies the confidence level for this recognition result. A value of 0.0 indicates minimum confidence, and a value of 1.0 indicates maximum confidence.
application.lastresult$[i].utterance, which is the raw string of words that compose this recognition result. The exact tokenization and spelling is platform-specific (e.g. “five hundred thirty” or “5 hundred 30” or even “530”).
application.lastresult$[i].inputmode, which specifies the mode in which the user provided the voice utterance. Typically, the value is voice for a voice utterance.
application.lastresult$[i].interpretation, which is an ECMAScript variable containing output from ECMAScript post-processing script typically used to reformat the value contained in the ‘utterance’ shadow variable.

Using the shadow variables above, the ASR engine (150) may generate the recognition result (508) according to the method of FIG. 5 by storing the word combination with the highest probability in ‘application.lastresult$.utterance’ and the probability associated with the word combination in ‘application.lastresult$.confidence.’

The method of FIG. 5 also includes determining (510), by an action classifier (132) for the VoiceXML interpreter (192), an action identifier (514) in dependence upon the recognition result (508). The action identifier (514) of FIG. 5 specifies an action to be performed by the multimodal application (195). In the example of FIG. 5, the action identifier (514) includes a plurality of action class identifiers (516). Each action class identifier (516) specifies an action class to which the specified action belongs. For further explanation, consider the following exemplary action identifier ‘voice.answer.’ The exemplary action identifier ‘voice.answer’ is composed of two action class identifiers ‘voice’ and ‘answer.’ The action class identifier ‘voice’ specifies that the action identifier ‘voice.answer’ belongs to the ‘voice’ action class, while the action class identifier ‘answer’ specifies that the action identifier ‘voice.answer’ also belongs to the ‘answer’ action class. In the example above, the order of the action class identifiers (516) also indicates that the ‘answer’ action class is a subclass of the ‘voice’ action class.

The action classifier (132) may determine (510) an action identifier (514) according to the method of FIG. 5 by retrieving action class identifiers (516) from a recognition-action repository (511) based on the recognition result (508) and combining the action class identifiers (516) to form the action identifier (514). For further explanation, consider the following exemplary recognition-action repository:

RECOGNITION-ACTION REPOSITORY

| RECOGNITION RESULT | CLASS | SUB-CLASS |
|---|---|---|
| call home | voice | dial |
| dial the house | voice | dial |
| phone home | voice | dial |
| answer the phone | voice | answer |
| pick up the phone | voice | answer |
| get the line | voice | answer |

Further consider that the recognition result generated by the ASR engine (150) is “answer the phone.” Using the exemplary recognition-action repository above, the action classifier (132) may retrieve the action class identifiers ‘voice’ and ‘answer,’ and combine the action class identifiers with periods to form the action identifier ‘voice.answer.’ Although the recognition-action repository (511) of FIG. 5 may be implemented using a table as illustrated above, recognition-action repository may also be implemented using other data structures as will occur to those of skill in the art such as, for example, linked-lists, tree structures, and so on. The multimodal application (195) may specify the particular recognition-action repository for use by the action classifier (132) using the <grammar> element and the element's ‘src’ and ‘type’ attributes. For example, the exemplary grammar element ‘<grammar src=“ac/ac.le” type=“recog-action-repos”/>’ specifies a recognition-action repository contained in a ‘ac.le’ file.

Similar to the recognition result (508) of FIG. 5, the action identifier (514) of FIG. 5 may be represented as an ECMAScript data structure. The action classifier (132) may represent the action identifier (514) as an ECMAScript data structure by representing the action class identifiers (516) as nested ECMAScript objects. In this manner, the action identifier is represented as a chain of linked ECMAScript objects. For further explanation, again consider the exemplary recognition-action repository above and an action identifier ‘voice.answer’ composed of the action identifiers ‘voice’ and ‘answer.’ The action classifier (132) may represent the action identifier ‘voice.answer’ as an ECMAScript data structure by creating ECMAScript objects representing the ‘answer’ and ‘voice’ action class identifiers and storing ECMAScript object representing the ‘answer’ action class identifier in the ECMAScript object representing the ‘voice’ action class identifier. Using dot notation, the ECMAScript data structure representing such an exemplary action identifier may be specified as ‘voice.answer.’

In the method of FIG. 5, determining (510), by an action classifier (132) for the VoiceXML interpreter (192), an action identifier (514) in dependence upon the recognition result (508) includes linking (512) the ECMAScript data structure representing the action identifier (514) to the ECMAScript data structure representing the recognition result (508). The action classifier (132) may link (512) the ECMAScript data structure representing the action identifier (514) to the ECMAScript data structure representing the recognition result (508) according to the method of FIG. 5 by storing the chain of ECMAScript objects used to represent the action identifier (514) in a shadow variable of the ECMAScript data structure representing the recognition result (508). Continuing with the exemplary ‘voice.answer’ action identifier above, the action classifier (132) may store the chain of ECMAScript objects used to represent the action identifier (514) in a shadow variable ‘ac’ of the ‘application.lastresult$’ array representing the recognition result (508), resulting in the following ECMAScript structure:
application.lastresult$.ac.voice.answer

The shadow variable ‘ac’ is an ECMAScript object used to store the chain of ECMAScript objects representing the action identifier ‘voice.answer.’

The method of FIG. 5 also includes interpreting (518), by the VoiceXML interpreter (192), the multimodal application (195) in dependence upon the action identifier (514). The VoiceXML interpreter (192) may interpret (518) the multimodal application (195) according to the method of FIG. 5 by parsing the VoiceXML segments of the X+V page (124) of the multimodal application into discrete executable segments, translating those segments into machine-readable instructions, and executing the machine-readable instructions.

In the method of FIG. 5, interpreting (518), by the VoiceXML interpreter (192), the multimodal application (195) in dependence upon the action identifier (514) includes performing (520) a particular action (500) specified in the multimodal application (195) for the action identifier (514). The X+V page (124) of the multimodal application (195) in FIG. 5 specifies particular actions to be performed by the multimodal application (195) based on action identifiers. For example, consider the following segment of an exemplary X+V page:

```
<vxml:form id=“vMainMenu”>
    ...
    <vxml:field name=“f1” slot=“ac.voice.dial”>
        <vxml:filled>
            <return event=“goto.vVoiceDialMenu”/>
        </vxml:filled>
    </vxml:field>
    < vxml:field name=“f2” slot=“ac.voice.answer”>
        <vxml:filled>
            <return event=“goto.vVoiceAnswerMenu”/>
        </vxml:filled>
    </vxml:field>
    ...
</vxml:form>
```

which specifies two actions using the VoiceXML <filled> element and associates each action with a different action identifier using the ‘slot’ attribute of the VoiceXML <field> element. In the example above, the action ‘<return event=“goto.vVoiceDialMenu”/>’ instructs the FIA of a VoiceXML interpreter to end execution of the ‘vMainMenu’ dialog and throw the ‘goto.vVoiceDialMenu’ event—resulting in a Voice Dial menu being presented to the user. The action ‘<return event=“goto.vVoiceAnswerMenu”/>’ instructs the FIA of a VoiceXML interpreter to end execution of the ‘vMainMenu’ dialog and throw the ‘goto.vVoiceAnswerMenu’ event—resulting in a Voice Answer menu being presented to the user.

To further understand how the VoiceXML interpreter (192) performs a particular action specified in the multimodal application, readers will note that each of the exemplary <filled> elements above is only executed by the VoiceXML interpreter (192) when the VoiceXML interpreter (192) is able to fill the field specified by the parent <field> element with a value. For example, the VoiceXML interpreter (192) will execute the ‘<return event=“goto.vVoiceDialMenu”/>’ action when the field ‘f1’ is filled with a value from the recognition result ‘application.lastresult$.’ Readers will further note that the value used by the VoiceXML interpreter (192) to fill the field specified by the <field> element is the value for the ECMAScript object specified by the ‘slot’ attribute of the <field> element. For example, when the <field> element has a ‘slot’ value of ‘ac.voice.answer,’ the VoiceXML interpreter (192) fills the value for the field with the value specified in the ‘application.lastresult$.ac.voice.answer’ ECMAScript data structure. However, if the ECMAScript object specified by the ‘slot’ attribute of the <field> element does not exist, the VoiceXML interpreter (192) will not fill the field specified by the <field> element with a value, and therefore will not perform the action specified in the <filled> child element of the <field> element.

Continuing with the segment from an exemplary X+V page above, if the action classifier (132) determines the action identifier (514) to be ‘voice.answer,’ then the action classifier (132) links (512) the ECMAScript data structure representing the ‘voice.answer’ action identifier to the ECMAScript date structure ‘application.lastresult$’ representing the recognition result (508), yielding:
application.lastresult$.ac.voice.answer.

When the VoiceXML interpreter (192) interprets the exemplary segment above, field ‘f2’ is filled with a value contained in the ECMAScript structure application.lastresult$.ac.voice.answer. Field ‘f1,’ however, is not filled with a value and remains undefined because the ECMAScript data structure ‘application.lastresult$.ac.voice.dial’ does not exist because the action classifier (132) did not determine that the action identifier ‘voice.dial’ corresponded to the recognition result (508) generated by the ASR engine (506).

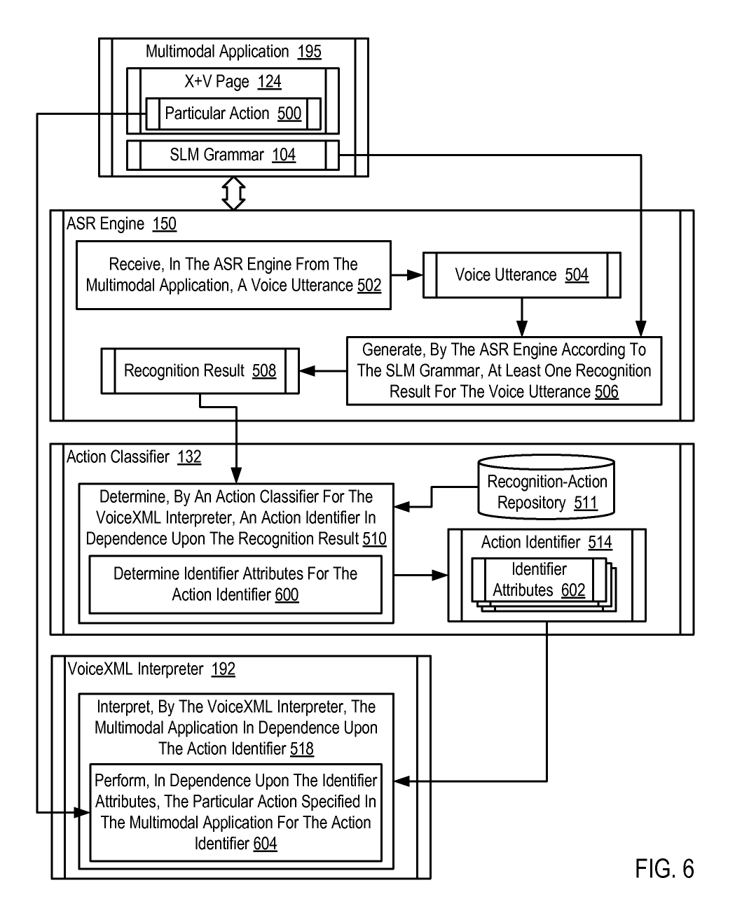

In addition to performing a particular action specified in the multimodal application for an action identifier, a VoiceXML interpreter may perform a particular action based on identifier attributes that specify characteristics for the action identifier. For further explanation, FIG. 6 sets forth a flow chart illustrating a further exemplary method of enabling natural language understanding using an X+V page of a multimodal application according to embodiments of the present invention that includes performing (604), in dependence upon the identifier attributes (602), the particular action (500) specified in the multimodal application (195) for the action identifier (514).

Enabling natural language understanding using an X+V page (124) of a multimodal application (195) according to the method of FIG. 6 is implemented with a statistical language model (‘SLM’) grammar (104) of the multimodal application (105) in an ASR engine (150) and with the multimodal application (195) operating in a multimodal browser on a multimodal device supporting multiple modes of interaction including a voice mode and one or more non-voice modes. The multimodal application (195) is operatively coupled to the ASR engine (150) through a VoiceXML interpreter (192).

The method of FIG. 6 is similar to the method of FIG. 5. That is, the method of FIG. 6 includes: receiving (502), in the ASR engine (150) from the multimodal application (195), a voice utterance (504); generating (506), by the ASR engine (150) according to the SLM grammar (104), at least one recognition result (508) for the voice utterance (504); determining (510), by an action classifier (132) for the VoiceXML interpreter (192), an action identifier (514) in dependence upon the recognition result (508), the action identifier (514) specifying an action to be performed by the multimodal application (195); and interpreting (518), by the VoiceXML interpreter (192), the multimodal application (195) in dependence upon the action identifier (514). That method of FIG. 6 is also similar to the method of FIG. 5 in that the method of FIG. 6 includes a recognition-action repository (511) that associates action identifier with recognition results.

The method of FIG. 6 differs from the method of FIG. 5 in that determining (510) an action identifier (514) in dependence upon the recognition result (508) also includes determining (600) identifier attributes (602) for the action identifier (514).

The identifier attributes (602) of FIG. 6 specify characteristics for the action identifier (514). These characteristics may include for example, confidence that the action identifier specifies the action intended by the user, text representing the action identifier, text representing the action class identifiers that comprise the action identifier, or any other attribute as will occur to those of skill in the art. The identifier attributes (602) may be represented using ECMAScript data structures that are stored as elements of the ECMAScript object representing the action identifier. For example, an identifier attribute specifying confidence for the action identifier ‘voice.answer’ may be represented as the following ECMAScript data structure:
application.lastresult$.ac.voice.answer.confidence

Using the exemplary data structure above, the action classifier (132) may determine (600) an identifier attribute (602) for the action identifier (514) according to the method of FIG. 6 by calculating a confidence level for the action identifier (514) based on the probability for the recognition result (508) generated by the ASR engine (150) and storing the calculated value in the exemplary data structure above.

In the example of FIG. 6, the multimodal application (195) specifies a particular action (500) for the action identifier (514). After the action classifier (132) has determined one or more identifier attributes (602), the VoiceXML interpreter (192) may perform (604) the particular action (500) in dependence upon the identifier attributes (602). In the method of FIG. 6, therefore, interpreting (518), by the VoiceXML interpreter (192), the multimodal application (195) in dependence upon the action identifier (514) includes performing (604), in dependence upon the identifier attributes (602), the particular action (500) specified in the multimodal application (195) for the action identifier (514). The VoiceXML interpreter (192) may perform (604) the particular action (500) in dependence upon the identifier attributes (602) according to the method of FIG. 6 by parsing the X+V page (124) of the multimodal application (195) into segments of executable code and executing the segments based on values for the identifier attributes (602).

For further explanation of performing (604) the particular action (500) in dependence upon the identifier attributes (602), consider the following segment of an exemplary X+V page,

```
<vxml:form id=“vMainMenu”>
    ...
    <vxml:field name=“f1” slot=“ac.voice.dial”>
        <vxml:filled>
        <if cond=“application.lastresult$.ac.voice.dial.confidence
        &gt; .3”>
            <return event=“goto.vVoiceDialMenu”/>
        </if>
        </vxml:filled>
    </vxml:field>
    ...
</vxml:form>
```

which specifies an action ‘<return event=“goto.vVoiceDialMenu”/>’ based on an identifier attribute ‘confidence.’ As explained above with reference to FIG. 5, the VoiceXML interpreter (192) will execute the <filled> element if the action classifier (132) determines that the action identifier ‘voice.dial’ matches the recognition result (508) generated by the ASR engine (150). The VoiceXML interpreter (192) executes the <filled> element because the action classifier (132) used the action identifier ‘voice.dial’ to generate the ECMAScript data structure,
application.lastresult$.ac.voice.dial,
   which the VoiceXML interpreter (192) used to fill the value of the field ‘f1’ as specified by the field's ‘slot’ attribute. The VoiceXML interpreter (192), however, only performs the action specified in the exemplary <filled> element above if the value of the ‘confidence’ identifier attribute is greater than thirty percent. Readers will note that the example provided above is for explanation only and not for limitation.

Exemplary embodiments of the present invention are described largely in the context of a fully functional computer system for enabling natural language understanding using an X+V page. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of enabling natural language understanding using an X+V page of a multimodal application, the method implemented with a statistical language model (‘SLM’) grammar of the multimodal application in an automatic speech recognition (‘ASR’) engine, with the multimodal application operating in a multimodal browser on a multimodal device supporting multiple modes of interaction including a voice mode and one or more non-voice modes, the multimodal application operatively coupled to the ASR engine through a VoiceXML interpreter, the method comprising:
receiving, in the ASR engine from the multimodal application, a voice utterance;
generating, by the ASR engine according to the SLM grammar, at least one recognition result for the voice utterance;
determining, by an action classifier for the VoiceXML interpreter, an action identifier in dependence upon the recognition result, the action identifier specifying an action to be performed by the multimodal application; and
interpreting, by the VoiceXML interpreter, the multimodal application in dependence upon the action identifier.

2. The method of claim 1 wherein the action identifier further comprises a plurality of action class identifiers, each action class identifier specifying an action class to which the specified action belongs.

3. The method of claim 1 wherein:
the multimodal application specifies a particular action for the action identifier; and
interpreting, by the VoiceXML interpreter, the multimodal application in dependence upon the action identifier further comprises performing the particular action specified in the multimodal application for the action identifier.

4. The method of claim 1 wherein:
the recognition result and the action identifier are represented as ECMAScript data structures; and
determining, by an action classifier for the VoiceXML interpreter, an action identifier in dependence upon the recognition result further comprises linking the ECMAScript data structure representing the action identifier to the ECMAScript data structure representing the recognition result.

5. The method of claim 1 wherein determining, by an action classifier for the VoiceXML interpreter, an action identifier in dependence upon the recognition result further comprises determining identifier attributes for the action identifier, the identifier attributes specifying characteristics for the action identifier.

6. The method of claim 5 wherein:
the multimodal application specifies a particular action for the action identifier; and
interpreting, by the VoiceXML interpreter, the multimodal application in dependence upon the action identifier further comprises performing, in dependence upon the identifier attributes, the particular action specified in the multimodal application for the action identifier.

7. Apparatus for enabling natural language understanding using an X+V page of a multimodal application, the apparatus implemented with a statistical language model (‘SLM’) grammar of the multimodal application in an automatic speech recognition (‘ASR’) engine, with the multimodal application operating in a multimodal browser on a multimodal device supporting multiple modes of interaction including a voice mode and one or more non-voice modes, the multimodal application operatively coupled to the ASR engine through a VoiceXML interpreter, the apparatus comprising a computer processor and a computer memory operatively coupled to the computer processor, the computer memory having disposed within it computer program instructions capable of:
receiving, in the ASR engine from the multimodal application, a voice utterance;
generating, by the ASR engine according to the SLM grammar, at least one recognition result for the voice utterance;
determining, by an action classifier for the VoiceXML interpreter, an action identifier in dependence upon the recognition result, the action identifier specifying an action to be performed by the multimodal application; and
interpreting, by the VoiceXML interpreter, the multimodal application in dependence upon the action identifier.

8. The apparatus of claim 7 wherein the action identifier further comprises a plurality of action class identifiers, each action class identifier specifying an action class to which the specified action belongs.

9. The apparatus of claim 7 wherein:
the multimodal application specifies a particular action for the action identifier; and
interpreting, by the VoiceXML interpreter, the multimodal application in dependence upon the action identifier further comprises performing the particular action specified in the multimodal application for the action identifier.

10. The apparatus of claim 7 wherein:
the recognition result and the action identifier are represented as ECMAScript data structures; and
determining, by an action classifier for the VoiceXML interpreter, an action identifier in dependence upon the recognition result further comprises linking the ECMAScript data structure representing the action identifier to the ECMAScript data structure representing the recognition result.

11. The apparatus of claim 7 wherein determining, by an action classifier for the VoiceXML interpreter, an action identifier in dependence upon the recognition result further comprises determining identifier attributes for the action identifier, the identifier attributes specifying characteristics for the action identifier.

12. The apparatus of claim 11 wherein:
the multimodal application specifies a particular action for the action identifier; and
interpreting, by the VoiceXML interpreter, the multimodal application in dependence upon the action identifier further comprises performing, in dependence upon the identifier attributes, the particular action specified in the multimodal application for the action identifier.

13. A computer program product for enabling natural language understanding using an X+V page of a multimodal application, the computer program product implemented with a statistical language model (‘SLM’) grammar of the multimodal application in an automatic speech recognition (‘ASR’) engine, with the multimodal application operating in a multimodal browser on a multimodal device supporting multiple modes of interaction including a voice mode and one or more non-voice modes, the multimodal application operatively coupled to the ASR engine through a VoiceXML interpreter, the computer program product disposed upon a computer-readable, signal-bearing medium, the computer program product comprising computer program instructions capable of:
receiving, in the ASR engine from the multimodal application, a voice utterance;
generating, by the ASR engine according to the SLM grammar, at least one recognition result for the voice utterance;
determining, by an action classifier for the VoiceXML interpreter, an action identifier in dependence upon the recognition result, the action identifier specifying an action to be performed by the multimodal application; and
interpreting, by the VoiceXML interpreter, the multimodal application in dependence upon the action identifier.

14. The computer program product of claim 13 wherein the computer-readable, signal-bearing medium comprises a recordable medium.

15. The computer program product of claim 13 wherein the computer-readable, signal-bearing medium comprises a transmission medium.

16. The computer program product of claim 13 wherein the action identifier further comprises a plurality of action class identifiers, each action class identifier specifying an action class to which the specified action belongs.

17. The computer program product of claim 13 wherein:
the multimodal application specifies a particular action for the action identifier; and
interpreting, by the VoiceXML interpreter, the multimodal application in dependence upon the action identifier further comprises performing the particular action specified in the multimodal application for the action identifier.

18. The computer program product of claim 13 wherein:
the recognition result and the action identifier are represented as ECMAScript data structures; and
determining, by an action classifier for the VoiceXML interpreter, an action identifier in dependence upon the recognition result further comprises linking the ECMAScript data structure representing the action identifier to the ECMAScript data structure representing the recognition result.

19. The computer program product of claim 13 wherein determining, by an action classifier for the VoiceXML interpreter, an action identifier in dependence upon the recognition result further comprises determining identifier attributes for the action identifier, the identifier attributes specifying characteristics for the action identifier.

20. The computer program product of claim 19 wherein:
the multimodal application specifies a particular action for the action identifier; and
interpreting, by the VoiceXML interpreter, the multimodal application in dependence upon the action identifier further comprises performing, in dependence upon the identifier attributes, the particular action specified in the multimodal application for the action identifier.
